(19) United States
(12) Patent Application Publication
(10) Pub. No.: US 2025/0259560 A1
(43) Pub. Date: Aug. 14, 2025

(54) ALARMS SIMULATOR

(71) Applicant: SAUDI ARABIAN OIL COMPANY, Dhahran (SA)

(72) Inventors: Ibrahim Ali Al Meftah, Al Qatif (SA); Hassan Shaker Ali Al-Sinan, Al Qatif (SA); Abdullatif Mohammed Abdulrahman Alomair, Dammam (SA)

(73) Assignee: SAUDI ARABIAN OIL COMPANY, Dhahran (SA)

(21) Appl. No.: 18/438,834

(22) Filed: Feb. 12, 2024

(51) Int. Cl. G09B 5/02

(52) U.S. Cl. CPC G09B 5/02

(57) ABSTRACT

System and method for an alarms simulator including selecting an alarm type from a plurality of alarm types, customizing the selected alarm type based, at least in part, on environment and operations data of a user by configuring at least one parameter for the selected alarm type, and replicating the customized alarm type. The method further includes practicing responding to the replicated customized alarm type in a practice mode operated on the alarms simulator, operating the alarms simulator in a test mode to train and test knowledge of the plurality of alarm types including the customized alarm type, and displaying, via a display on the alarms simulator, a result of the test mode representing an accuracy of immediate feedback from the user during test mode.

### BACKGROUND

Safety and emergency response preparedness training is vital to most industries, especially oil and gas. Traditional training lacks realistic alarm scenarios that results in inadequate preparation for actual emergencies. Further, there is no convenient way of learning alarm systems and training for emergencies. Accordingly, there exists a need for an alarms simulator which provides a platform that is capable of enhancing safety knowledge, improving emergency response preparedness, and providing training tools for individuals and organizations to effectively respond to various safety and real-life alarm situations.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to an alarms simulator comprising: a practice mode configured to replicate a selected alarm type from a plurality of alarm types to train a user on the plurality of alarm types based, at least in part, on a response of the user, wherein the selected alarm type comprises a customized alarm type comprising at least one parameter based, at least in part, on environment and operations data of the user; a test mode configured to train and test knowledge of the plurality of alarm types including the customized alarm type based, at least in part, on an immediate feedback input by the user; and a display configured to display a result of the test mode representing an accuracy of the immediate feedback input from the user.

In one aspect, embodiments disclosed herein relate to a method for using an alarms simulator, the method comprising: selecting an alarm type from a plurality of alarm types; customizing the selected alarm type based, at least in part, on environment and operations data of a user by configuring at least one parameter for the selected alarm type; replicating the customized alarm type; practicing responding to the replicated customized alarm type in a practice mode operated on the alarms simulator; operating the alarms simulator in a test mode to train and test knowledge of the plurality of alarm types including the customized alarm type; and displaying, via a display on the alarms simulator, a result of the test mode representing an accuracy of immediate feedback from the user during test mode.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIG. 1 shows a system in accordance with one or more embodiments.

FIG. 2 shows a device in accordance with one or more embodiments.

FIG. 3 shows a device used in conjunction with FIGS. 1 and 2 in accordance with one or more embodiments.

FIG. 4 shows a device in accordance with one or more embodiments.

FIG. 5 shows a flowchart in accordance with one or more embodiments.

FIG. 6 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

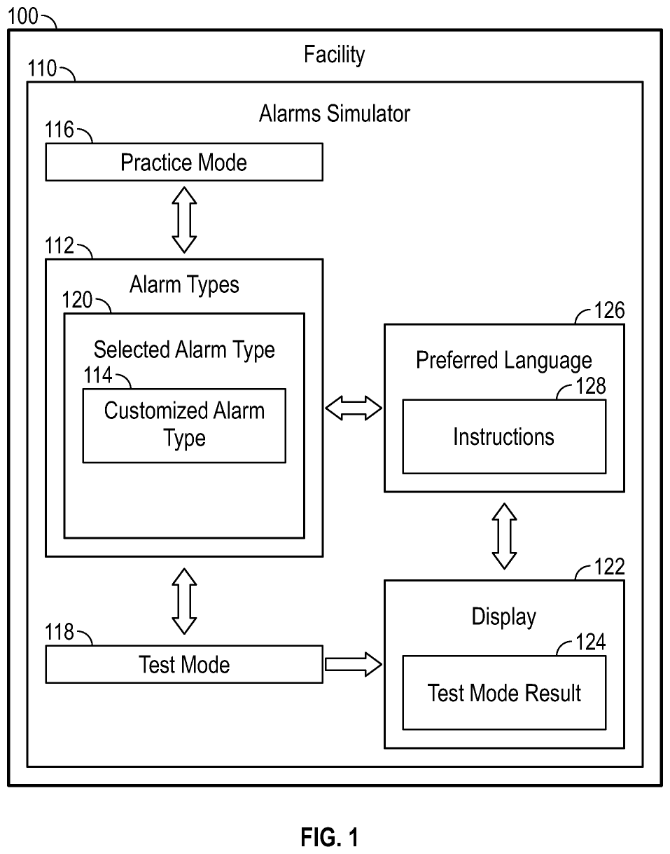

In the following description of FIGS. 1-6, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a force applicator” includes reference to one or more of such force applicators.

In one aspect, embodiments disclosed herein relate to an alarms simulator and a method for using the alarms simulator. The alarms simulator is a versatile device designed to replicate a variety of alarms tailored to individual end-user requirements. The alarms simulator further facilitates training and evaluates responses to various alarms in industrial and emergency events. The functionality of the alarms simulator includes training individuals on alarms commonly encountered in industrial and emergency scenarios to allow users to practice and test their knowledge. In one or more embodiments, the alarms simulator provides a valuable tool for training and testing responses to alarms in a customizable manner to promote safety and preparedness with various industrial settings. The ability to customize the alarms simulator provides a tailored training experience. In traditional safety training, individuals and users are often confused with various alarm sounds. The confusion makes it challenging for users to respond effectively during real emergencies. The alarms simulator provides a platform to replicate a wide range of alarms for practice and training purposes to alleviate confusion and train users to respond effectively during real emergencies.

FIG. 1 shows a system in accordance with one or more embodiments. Specifically, FIG. 1 shows a diagram illustrating a facility (100) with an alarms simulator (110). The facility (100) may be a manufacturing building such as a maintenance building, an original equipment manufacturer (OEM), or a Coast Centre Base (CCB). The facility (100) may be any facility or building that may require alarm or emergency training of their personnel, such as retail facilities or service facilities. For example, the facility (100) may be but is not limited to a chemical plant, a chemical storage facility, a gas storage facility, a hospital, a government agency, a school/campus, a restaurant, a hotel, an office, a factory, a lab, and/or a warehouse. The alarms simulator (110) may be integrated into various training and onboarding programs, including safety orientation sessions, pre-job safety talks, and safety campaigns. The alarms simulator (110) may be a device or system similar to an alarm panel, device, or system. The alarms simulator (110) may include two models, such as a portable configuration and a fixed mode configuration, for availability and flexibility purposes. The two models may accommodate a wide range of training scenarios. The portable configuration may provide a means to use the alarms simulator (110) in any location at any time for on-the-go training scenarios. The fixed mode configuration may provide a means to install the alarms simulator (110) as a permanent fixture in any manufacturing building or facility (100) for continuous use.

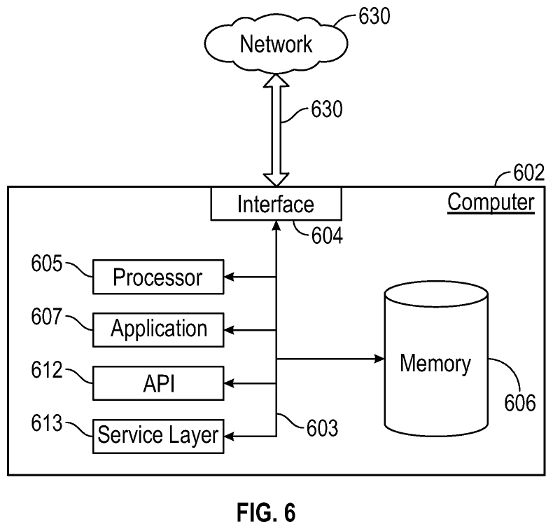

The alarms simulator (110) may include a variety of buttons to operate the alarms simulator (110). Alternatively, the alarms simulator (110) may include a touch screen. The alarms simulator (110) may include a processor (e.g., processor (605)), further described in FIG. 6, for programming codes. For example, a plurality of alarm types (112) may be programmed into the alarms simulator (110). A person of ordinary skill in the art would appreciate that the alarm types (112) may include but are not limited to, a hydrogen sulfide (H2S) alarm, a lower explosive limit (LEL) alarm, a fire alarm, a carbon monoxide alarm, a general emergency alarm, an all clear alarm, a stop work alarm, and a chemical spill alert. As each facility (100) requires different types of alarms, a user may change any of the alarm types (112) conveniently using the alarms simulator (110). The alarm types (112) may be selected or changed using the alarms simulator (110) using buttons, dropdown lists, menus, or toggles. For example, the names of the alarm types (112) may be changed in the alarms simulator (110). The user may be any individual in the facility (100), such as safety trainee, new employee, and/or an operator. As stated above, each facility (100) requires different types of alarms. For example, some facilities require six alarms, whereas some offshore facilities require nine alarms. The alarms simulator (110) may allow a user to request certain alarms or add as many alarms as desired.

In one or more embodiments, any of the alarm types (112) may be customized based on at least one parameter including a user's environment and operations. A customized alarm type (114) option in the alarms simulator (110) may offer capability to create and replicate specific alarms as per the unique needs of an end user. Including at least one parameter during customization may ensure that the alarm types (112) are relevant to a user's particular environment and industry. For example, the customized alarm type (114) may include selecting sound intensity and duration of the alarm sound. Activation triggers may also be customized in the alarms simulator (110). In some embodiments, a sound file including various alarm sounds may be used and changed in the programming of the alarms simulator (110) for customizing any of the alarm types (112). The sound file may be a Moving Picture Experts Group Audio Layer 3 (MP3) file type. The customized alarm type (114) may help simulate alarms in the exact conditions that users would encounter in their respective workplaces.

In one or more embodiments, the alarms simulator (110) includes two distinct modes of operation including a practice mode (116) and a test mode (118). In practice mode (116), one or more selected alarm types (120) may be chosen from the list of alarm types (112) to be replicated. Practice mode (116) is designed to train any user on the alarm types (112). For example, users may manually trigger any of the alarm types (112) by pressing the designated buttons on the alarm simulator (110). Triggering the selected alarm type (120) may transmit an alarm sound designated for the selected alarm type (120). This practice mode (116) may help users familiarize themselves with the alarm types (112). The practice mode (116) trains the knowledge of the user based on the response of the user to each selected alarm type (120). Practice mode (116) may include simulating alarm sounds by activating an “on demand” configuration for each selected alarm type (120). A person of ordinary skill in the art would appreciate that the practice mode (116) may aide in learning and refreshing knowledge on all alarm types (112).

In test mode (118), the user is tested on their knowledge of the alarm types (112) including the customized alarm type (114) based on an immediate feedback input by the user. In one or more embodiments, test mode (118) challenges users by randomly selecting and activating one or more of the alarm types (112) including the customized alarm types (114). Activating the customized alarm type (114) may sound the designated alarm for that customized alarm type (114). The user must correctly identify and respond to the alarm sound by immediately (or within a predefined time) identifying the customized alarm type (114) and inputting the name or other identifier of the customized alarm type (114) into a user interface, such as a button pressing input, a typed input, a voice input, or any other suitable input into a user interface. For example, the button pressing input may include pressing the button of the respective customized alarm type (114) based on the alarm sound. The alarm simulator (110) includes a display (122) for displaying the test mode result (124). The test mode result (124) may appear after the immediate feedback input by the user. The test mode result (124) represents the accuracy of the immediate feedback input from the user. In some embodiments, the test mode result (124) may include results such as “correct”, “wrong”, or “timeout” shown on the display (122). “Timeout” may be displayed when there is no response within the predefined time by the user. The test mode result (124) may appear as an audio result, such as a beep or other sound indicating whether the test mode result (124) is correct, wrong, or timed out. Alternatively or in conjunction with the displayed result and/or audio result, the test mode result (124) may include a color indicator or light on the alarms simulator (110) for displaying a specific color to indicate each result. For example, the alarms simulator (110) may display a green light to indicate a correct result, a red light to indicate a correct result, or an orange/yellow light to indicate a timeout result. In one or more embodiments, the test mode result (124) may appear as a voice output result, such as using a speaker on the alarms simulator (110) to produce speech to tell a user the test mode result (124).

Immediate feedback from the user enables the user to evaluate and assess their performance by identifying areas of improvement. The user may then refine their responses to improve their responses to alarms based on the test mode result (124), for example by using the alarms simulator in practice mode (116) to improve accuracy of identifying alarm types. Test mode (118) may be applied during safety orientation, communication and safety meetings, and during major shutdown activities. Major shutdown activities may include a situation where more contractors than normal are residing in the facility (100), such as trade and industrial education personnel. Major shutdown activities may include safety hazards, scheduled maintenance, cleaning, servicing equipment, and inspections.

In one or more embodiments, the alarms simulator (110) includes a preferred language (126) selection. A person of ordinary skill in the art would appreciate that language differences in the industry can often hinder effective communication, especially during emergency situations. To cater to a diverse user base and mitigate language barriers, the alarms simulator (110) offers robust multi-language support including a multi-language interface, such as the preferred language (126) selection. The multi-language interface may facilitate effective communication and response training for users from diverse linguistic backgrounds. Users may select their preferred language (126) for labeling the alarm types (112), alarm notifications, and instructions (128). The instructions (128) may be a series of instructions regarding the alarms simulator (110). The preferred language (126) may be selected from a list of a large number of languages, including English, Spanish, Arabic, and Russian among others. The preferred language (126) selection may allow a user to receive instructions (128) in their preferred language.

In some embodiments, the alarms simulator (110) may include scalability for organizations to scale the use of the alarms simulator (110). Scalability may include seamlessly integrating the alarms simulator (110) into existing safety training programs or emergency preparedness initiatives. Organizations often scale their training programs as the programs grow. The alarms simulator (110) may aid in suitability for small teams or large organizations. Integration of the alarms simulator (110) into existing safety training programs may address problems involving adapting training tools to evolving operational requirements.

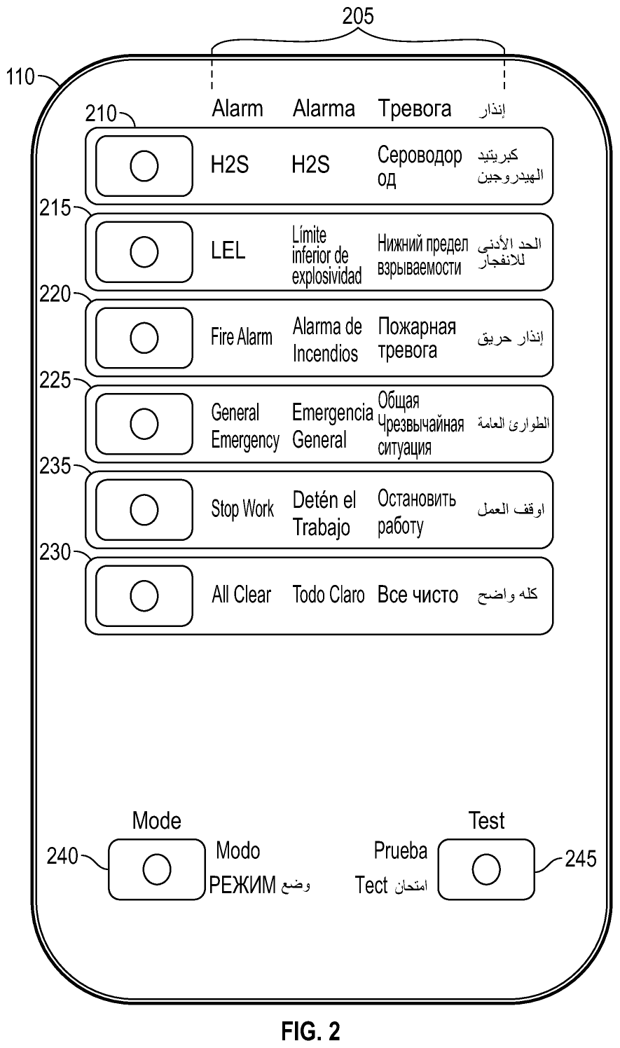

FIG. 2 shows a device in accordance with one or more embodiments. Specifically, FIG. 2 illustrates an alarms simulator (110) customized with six types of alarms (e.g., customized alarm type (114)) along with a multi-language interface (205) (e.g., preferred language (126)). The six alarm types include a H2S alarm (210), an LEL alarm (215), a fire alarm (220), a general emergency alarm (225), an all clear alarm (230), and a stop work alarm (235). In some embodiments, one or more alarms are customized to be connected together into a one system setup, especially for test mode (118). For example, the general emergency alarm (225) may be in the same system as the all clear alarm (230). In such instances, the general emergency alarm (225) announces an emergency and the all clear alarm (230) sounds to declare the end of the emergency after the general emergency alarm (225). A user may simulate all six of the alarms (210,215,220,225,230,235) on one device, such as the alarms simulator (110), without activating an actual alarm. Actual alarms may need further preparations and announcements and may cause panic.

In one or more embodiments, the multi-language interface (205) illustrated in FIG. 2 includes four languages. The four languages are English, Spanish, Russian, and Arabic. These four languages are used commonly in the industry. A person of ordinary skill in the art may appreciate that any other language along with any number of languages may be implemented into the alarms simulator (110).

As illustrated by FIG. 2, practice mode (e.g., practice mode (116)) may be activated by pressing a mode button (240). Once practice mode is activated, the alarms simulator (110) functions as described above in FIG. 1. Test mode (e.g., test mode (118)) may be activated by pressing a test mode button (245). Once test mode is activated, the alarms simulator (110) functions as described above in FIG. 1.

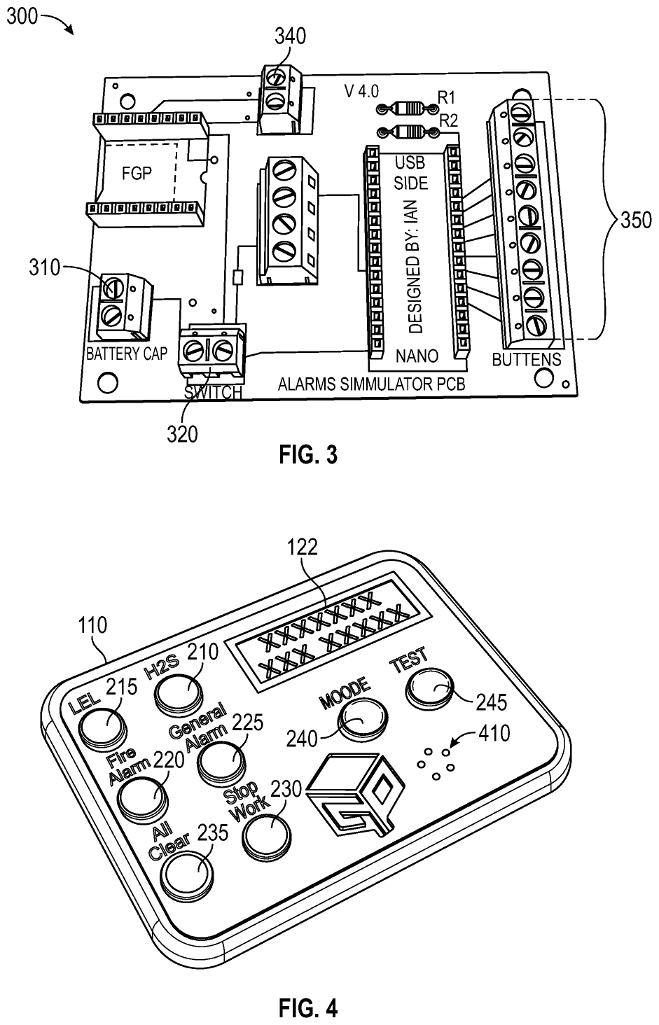

FIG. 3 shows a device used in conjunction with FIGS. 1 and 2 in accordance with one or more embodiments. Specifically, FIG. 3 shows a printed circuit board (300). The circuit board (300) may be integrated in the alarms simulator (110) as described in FIGS. 1 and 2. The circuit board (300) may include components such as a battery (310), a switch (320), a speaker (340), buttons (350), and programming codes (not shown). The circuit board (300) may include a processor (e.g., processor (605)) as described below in FIG. 6. A person of ordinary skill in the art may appreciate that the circuit board (300) may be designed and installed for computing, communicating, and transferring data for the alarms simulator (110).

FIG. 4 shows a device in accordance with one or more embodiments. Specifically, FIG. 4 shows another example of an alarms simulator (110) used in the industry. The alarms simulator (110) in FIG. 4 is a portable model and includes buttons for six alarm types including LEL alarm (215), H2S alarm (210), fire alarm (220), general alarm (e.g., general emergency alarm (225)), all clear (235), and stop work (230). The alarms simulator (110) further includes a test mode button (240) and a practice mode button (245). The alarms simulator (110) further includes a display (122) for displaying any of the alarm types and test mode results. The alarms simulator (110) may include a speaker (410) as shown in FIG. 4 for sounding any alarms selected (e.g., selected alarm type (120)).

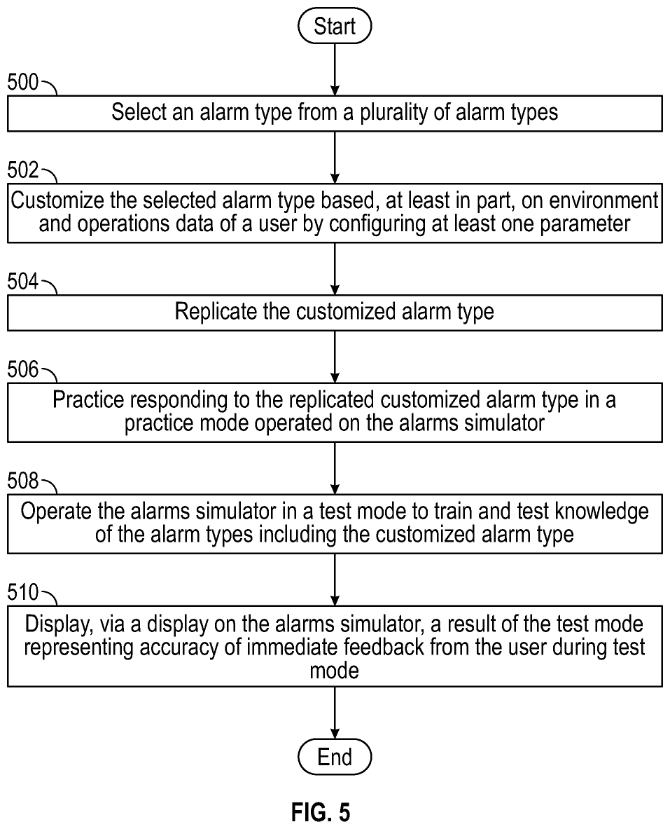

FIG. 5 shows a flowchart in accordance with one or more embodiments. Specifically, FIG. 5 describes the methodology for using an alarms simulator (e.g., alarms simulator (110)) as described in FIGS. 1-4. The alarms simulator may be portable or fixed to a manufacturing building, such as a maintenance building, an original equipment manufacturer, or a Coast Centre Base. While the various blocks in FIG. 5 are presented and described sequentially, one or ordinary skill in the art will appreciate that some or all of the blocks may be executed in different orders, may be combined or omitted, and some or all of the blocks may be executed in parallel. Furthermore, the blocks may be performed actively or passively.

In Block 500, an alarm type is selected from a plurality of alarm types. The alarm type may include a general emergency alarm, an all clear alarm, a stop work alarm, a hydrogen sulfide alarm, a lower explosive limit alarm, a carbon monoxide alarm, and a fire alarm. The alarm type may be selected by changing a name of each of the plurality of alarm types. For example, the alarms simulator may include a list of alarm type names that can be selected individually by choosing a different name on the list. The list may be navigated through a touch screen, a dropdown list, a menu, buttons, or breadcrumbs. In Block 502, the selected alarm type is customized based, at least in part, on environment and operations data of a user by configuring at least one parameter. The parameter may include, for example, any configurable part of an alarm, such as sound intensity and sound duration for the selected alarm type. A sound file containing various alarm sounds associated with the selected alarm may be modified to configure the parameter. For example, the selected alarm type may be customized by selecting an alarm sound from the sound file based on the parameter.

In Block 504, the customized alarm type is replicated. For example, an alarm sound specific to the customized alarm type is played through a speaker. In Block 506, the alarms simulator is operated in practice mode to practice responding to the replicated customized alarm type. For example, in practice mode, a user selects one or more alarm types including the customized alarm type to be replicated by pressing each alarm type button. When an alarm type is replicated, a respective alarm sound is played. The user trains and learns each alarm sound and the respective alarm type for each alarm sound by replicating the alarm types as many times as necessary.

In Block 508, the alarms simulator is operated in a test mode to train and test knowledge of the alarm types including the customized alarm type. For example, the user selects a test mode button to operate the alarms simulator in test mode. Once the test mode button is pressed, the alarms simulator chooses one of the alarm types at random to play its respective alarm sound. The user then provides immediate feedback by choosing an alarm type that the user thinks is the correct alarm type that was played. The alarms simulator processes the immediate feedback and responds with a result indicating whether the user was correct, wrong, or timed out.

In Block 510, the result of the test mode representing accuracy of immediate feedback from the user during the test mode is displayed, via a display on the alarms simulator. For example, the result indicating whether the user's immediate feedback was correct, wrong, or timed out is displayed on a screen. A preferred language may be selected for labeling the plurality of alarm types. The preferred language selected may include a series of instructions reported in the preferred language regarding the alarms simulator.

Embodiments of the alarms simulator may be implemented on a computer system. FIG. 6 is a block diagram of a computer system (602) used to provide computational functionalities associated with described algorithms, methods, functions, processes, flows, and procedures as described in the instant disclosure, according to an implementation. The illustrated computer (602) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (602) may include a computer that includes an input device, such as a keypad, keyboard, touch screen, or other device that can accept user information, and an output device that conveys information associated with the operation of the computer (602), including digital data, visual, or audio information (or a combination of information), or a GUI.

The computer (602) can serve in a role as a client, network component, a server, a database or other persistency, or any other component (or a combination of roles) of a computer system for performing the subject matter described in the instant disclosure. The illustrated computer (602) is communicably coupled with a network (630). In some implementations, one or more components of the computer (602) may be configured to operate within environments, including cloud-computing-based, local, global, or other environment (or a combination of environments).

At a high level, the computer (602) is an electronic computing device operable to receive, transmit, process, store, or manage data and information associated with the described subject matter. According to some implementations, the computer (602) may also include or be communicably coupled with an application server, e-mail server, web server, caching server, streaming data server, business intelligence (BI) server, or other server (or a combination of servers).

The computer (602) can receive requests over network (630) from a client application (for example, executing on another computer (602)) and responding to the received requests by processing the said requests in an appropriate software application. In addition, requests may also be sent to the computer (602) from internal users (for example, from a command console or by other appropriate access method), external or third-parties, other automated applications, as well as any other appropriate entities, individuals, systems, or computers.

Each of the components of the computer (602) can communicate using a system bus (603). In some implementations, any or all of the components of the computer (602), both hardware or software (or a combination of hardware and software), may interface with each other or the interface (604) (or a combination of both) over the system bus (603) using an application programming interface (API) (612) or a service layer (613) (or a combination of the API (612) and service layer (613). The API (612) may include specifications for routines, data structures, and object classes. The API (612) may be either computer-language independent or dependent and refer to a complete interface, a single function, or even a set of APIs. The service layer (613) provides software services to the computer (602) or other components (whether or not illustrated) that are communicably coupled to the computer (602). The functionality of the computer (602) may be accessible for all service consumers using this service layer. Software services, such as those provided by the service layer (613), provide reusable, defined business functionalities through a defined interface. For example, the interface may be software written in JAVA, C++, or other suitable language providing data in extensible markup language (XML) format or other 3suitable format. While illustrated as an integrated component of the computer (602), alternative implementations may illustrate the API (612) or the service layer (613) as stand-alone components in relation to other components of the computer (602) or other components (whether or not illustrated) that are communicably coupled to the computer (602). Moreover, any or all parts of the API (612) or the service layer (613) may be implemented as child or sub-modules of another software module, enterprise application, or hardware module without departing from the scope of this disclosure.

The computer (602) includes an interface (604). Although illustrated as a single interface (604) in FIG. 6, two or more interfaces (604) may be used according to particular needs, desires, or particular implementations of the computer (602). The interface (604) is used by the computer (602) for communicating with other systems in a distributed environment that are connected to the network (630). Generally, the interface (includes logic encoded in software or hardware (or a combination of software and hardware) and operable to communicate with the network (630). More specifically, the interface (604) may include software supporting one or more communication protocols associated with communications such that the network (630) or interface's hardware is operable to communicate physical signals within and outside of the illustrated computer (602).

The computer (602) includes at least one computer processor (605). Although illustrated as a single computer processor (605) in FIG. 6, two or more processors may be used according to particular needs, desires, or particular implementations of the computer (602). Generally, the computer processor (605) executes instructions and manipulates data to perform the operations of the computer (602) and any algorithms, methods, functions, processes, flows, and procedures as described in the instant disclosure.

The computer (602) also includes a memory (606) that holds data for the computer (602) or other components (or a combination of both) that can be connected to the network (630). For example, memory (606) can be a database storing data consistent with this disclosure. Although illustrated as a single memory (606) in FIG. 6, two or more memories may be used according to particular needs, desires, or particular implementations of the computer (602) and the described functionality. While memory (606) is illustrated as an integral component of the computer (602), in alternative implementations, memory (606) can be external to the computer (602).

The application (607) is an algorithmic software engine providing functionality according to particular needs, desires, or particular implementations of the computer (602), particularly with respect to functionality described in this disclosure. For example, application (607) can serve as one or more components, modules, applications, etc. Further, although illustrated as a single application (607), the application (607) may be implemented as multiple applications (607) on the computer (602). In addition, although illustrated as integral to the computer (602), in alternative implementations, the application (607) can be external to the computer (602).

There may be any number of computers (602) associated with, or external to, a computer system containing computer (602), each computer (602) communicating over network (630). Further, the term “client,” “user,” and other appropriate terminology may be used interchangeably as appropriate without departing from the scope of this disclosure. Moreover, this disclosure contemplates that many users may use one computer (602), or that one user may use multiple computers (602).

In some embodiments, the computer (602) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AlaaS), and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. An alarms simulator comprising:
a practice mode configured to replicate a selected alarm type from a plurality of alarm types to train a user on the plurality of alarm types based, at least in part, on a response of the user,
wherein the selected alarm type comprises a customized alarm type comprising at least one parameter based, at least in part, on environment and operations data of the user;
a test mode configured to train and test knowledge of the plurality of alarm types including the customized alarm type based, at least in part, on an immediate feedback input by the user; and
a display configured to display a result of the test mode representing an accuracy of the immediate feedback input from the user.

2. The alarms simulator of claim 1, further comprising:
a preferred language selected for labeling the plurality of alarm types.

3. The alarms simulator of claim 2,
wherein a series of instructions regarding the alarms simulator is in the preferred language selected.

4. The alarms simulator of claim 1,
wherein the at least one parameter comprises sound intensity and sound duration for the selected alarm type.

5. The alarms simulator of claim 1,
wherein the plurality of alarm types comprises a hydrogen sulfide (H2S) alarm, a lower explosive limit (LEL) alarm, and a fire alarm.

6. The alarms simulator of claim 1,
wherein the plurality of alarm types comprises a general emergency alarm, an all clear alarm, and a stop work alarm.

7. The alarms simulator of claim 1,
wherein the customized alarm type comprises a sound file with various alarm sounds configured to be changed.

8. The alarms simulator of claim 1,
wherein the plurality of alarm types comprises a name for each of the plurality of alarm types,
wherein the name is configured to change.

9. The alarms simulator of claim 1,
wherein the alarms simulator is portable or fixed to a manufacturing building.

10. The alarms simulator of claim 9,
wherein the manufacturing building is a maintenance building, an original equipment manufacturer (OME), or a Coast Centre Base (CCB).

11. A method for using an alarms simulator, the method comprising:
selecting an alarm type from a plurality of alarm types;
customizing the selected alarm type based, at least in part, on environment and operations data of a user by configuring at least one parameter for the selected alarm type;
replicating the customized alarm type;
practicing responding to the replicated customized alarm type in a practice mode operated on the alarms simulator;
operating the alarms simulator in a test mode to train and test knowledge of the plurality of alarm types including the customized alarm type; and
displaying, via a display on the alarms simulator, a result of the test mode representing an accuracy of immediate feedback from the user during test mode.

12. The method of claim 11, further comprising:
selecting a preferred language for labeling the plurality of alarm types.

13. The method of claim 12, further comprising:
wherein selecting the preferred language comprises reporting a series of instructions in the preferred language regarding the alarms simulator.

14. The method of claim 11,
wherein configuring the at least one parameter comprises choosing sound intensity and sound duration for the selected alarm type.

15. The method of claim 11,
wherein selecting the alarm type comprises selecting a hydrogen sulfide (H2S) alarm, a lower explosive limit (LEL) alarm, and a fire alarm.

16. The method of claim 11,
wherein selecting the alarm type comprises selecting a general emergency alarm, an all clear alarm, and a stop work alarm.

17. The method of claim 11,
wherein customizing the selected alarm type comprises changing a sound file with various alarm sounds.

18. The method of claim 11,
wherein selecting the alarm type comprises changing a name of each of the plurality of alarm types.

19. The method of claim 11,
wherein the alarms simulator is portable or fixed to a manufacturing building.

20. The method of claim 19,
wherein the manufacturing building is a maintenance building, an original equipment manufacturer (OME), or a Coast Centre Base (CCB).
